(19) United States
(12) Patent Application Publication
(10) Pub. No.: US 2009/0208049 A1
(43) Pub. Date: Aug. 20, 2009

(54) Accessory For A Set Of Headphones

(75) Inventor: Jeffrey Filiberto, New York, NY (US)

Correspondence Address: Cozen O''Connor, 250 PARK AVENUE, NEW YORK, NY, 10177, US

(73) Assignee: Bluesies LLC, New York, NY (US)

(21) Appl. No.: 12/033,338

(22) Filed: Feb. 19, 2008

(51) Int. Cl. H04R 25/00

(52) U.S. Cl. 381/384

(57) ABSTRACT

The invention provides a headphone assembly comprising a set of headphones having at least one speaker, an input plug and a headphone wire connecting the input plug to the at least one speaker. The headphone assembly also includes decorative element connected to the headphone wire.

### FIELD OF THE INVENTION

The present invention relates generally to an accessory for a set of headphones and, more particularly, to a decorative element connected to the wire of the set of headphones.

### BACKGROUND OF THE INVENTION

In recent years, usage of portable music players such as the Ipod® brand music player sold by Apple Computer have become increasingly common. In fact, users of such portable music players, with “ear buds” affixed to their ears, have become almost ubiquitous, existing in virtually all public places including malls, airports, trains, buses and airplanes.

While a variety of portable music players having different designs and colors are available on the market, users desire additional ways to express themselves through, and/or individualize, their players. For example, specially designed cases for portable music players have been on the market for several years. In addition to providing protection from the elements and from damage resulting from drops and bumps, such cases serve the function of allowing the user to express his or her likes and dislikes and/or to distinguish his or her player from others. This can be accomplished by including printed indicia on the cases, such as licensed images relating to a user's favorite sports team or music band. In addition, services exist which decorate portable music players with colors, words, designs and corporate logos.

While there are numerous methods available for decorating one's portable music player, many of these methods are expensive and tedious to implement. For example, a portable music player can only be held in a single case, and purchasing multiple cases can be expensive. Carrying multiple cases can be difficult due to their rigidity and size. Further, portable music players are typically concealed in a user's pocket or bag when the user is in a public place. Such concealment of the portable music player prevents others from seeing the design of the case. Although some cases are sold with belt clips, they can be cumbersome to wear. In addition, many users choose not to wear their music players on their belts due to the increased risk of theft.

One available solution to the above problem is for the user to express his or her self through the set of headphones. For example, sets of headphones are presently sold with designs emblazoned on the exterior of the earbuds. However, these designs are not effective to convey information about the user as they are typically too small. Further, it is not economically feasible for most users to purchase multiple sets of headphones. As breakthroughs have been made in sound technology, headphones with good sound quality have become increasingly expensive.

### SUMMARY OF THE INVENTION

It is therefore an object of the present invention to provide a way to decorate a set of headphones to be used with portable music players, computers, DVD players and the like so that the user can express his or her self through, and/or individualize, the headphones.

It is another object of the present invention to provide a way to decorate a set of headphones so that a characteristic, trait or preference of the wearer is conveyed to the public.

It is yet another object of the present invention to provide a way to decorate a set of headphones in a way that is both inexpensive and easy to accomplish.

These and other objects of the invention are attained by providing, in connection with one embodiment of the invention, a headphone assembly having a set of headphones and a decorative element connected to the wire of the headphones. The decorative element conveys one or more characteristics, traits or preferences of the wearer, and can comprise a flat piece of material having printed indicia, a three-dimensional figurine such as a licensed superhero or cartoon character, or any other ornamental accessory. A connector device is provided for connecting the decorative element to the headphone wire. The connector device can either be integral with the decorative element or a separate element that cooperates with the decorative element through, e.g., an aperture formed in the decorative element.

In another embodiment of the invention, an assembly is provided which includes a decorative element and a connector element for connecting the decorative element to the headphone wire.

In another embodiment of the invention, a kit is provided, which includes a plurality of decorative elements, each structured and arranged to be coupled to a portion of a headphone wire of a set of headphones, and at least one connector for connecting the decorative element to the headphone wire.

In yet another embodiment of the invention, a method of decorating a set of headphones is provided. The headphones include an input plug and a headphone wire connecting the input plug to the speakers. The method includes providing at least one decorative element and coupling the decorative element to the headphone wire.

These and other features and advantages of this invention are described in or are apparent from the following detailed description of exemplary embodiments.

### BRIEF DESCRIPTION OF THE DRAWINGS

A more complete appreciation of the present invention and many of the attendant advantages thereof will be readily understood by reference to the following detailed description of preferred embodiments of the invention when taken in conjunction with the accompanying drawings, in which:

FIG. 1a is a front view of a headphone assembly in accordance with an embodiment of the present invention;

FIG. 1b is a front view of a headphone assembly in accordance with another embodiment of the present invention;

FIG. 2 is a front view of a connector device and decorative element in accordance with an embodiment of the invention;

FIGS. 3a-c illustrate a method of connecting a decorative element to a headphone wire using a connector device in accordance with the embodiment of the invention shown in FIG. 2;

FIGS. 4a-c illustrate a method of connecting a decorative element to a headphone wire using a connector portion of the decorative element in accordance with another embodiment of the invention;

FIGS. 5a-c illustrate a method of connecting a decorative element to a headphone wire using a connector portion of the decorative element in accordance with another embodiment of the invention;

FIG. 6a shows a kit in accordance with an embodiment of the present invention including a plurality of decorative elements;

FIG. 6b shows a kit in accordance with another embodiment of the present invention including a plurality of decorative elements;

FIG. 7 shows a close up view of the decorative element of FIG. 2; and

FIG. 8 is a front view showing the headphone assembly of one embodiment of the present invention being worn by a user.

### DETAILED DESCRIPTION OF THE PREFERRED EMBODIMENTS OF THE INVENTION

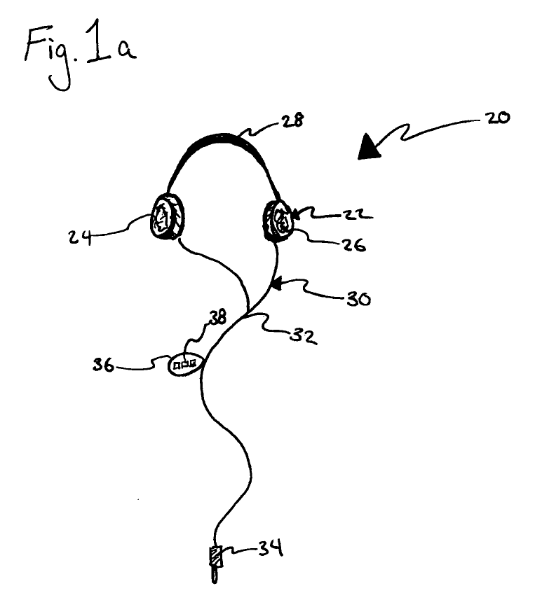

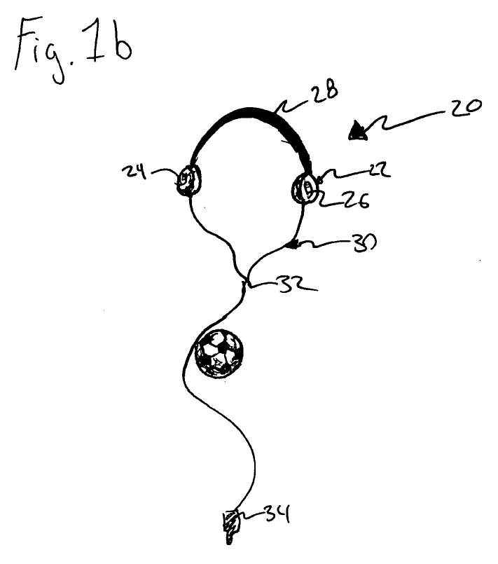

Referring now to the drawings, in which like reference characters designate identical or corresponding parts throughout the several views, and more particularly to FIG. 1a, a headphone assembly according to one embodiment of the present invention is designated generally with reference numeral 20. The headphone assembly 20 includes a pair of speakers 22, including a right unit 24 and a left unit 26. Speakers 22 may be earbuds, inner ear phones, traditional over-the-ear speakers or any other type of speakers.

Speakers 22 are coupled to a portable music player, computer, portable video game system, or any other audio/visual device, through a cable 30, which includes a headphone wire 32 and an input plug 34. Input plug 34 is structured and arranged to be received by a corresponding input jack of the audio/visual device.

A decorative element 36 is connected to wire 32 of headphone assembly 20. Decorative element 36 can be a flat piece of material as show in FIG. 1a, a 3-dimensional figurine as shown in FIG. 1b, or any other ornamental accessory that serves the function of decorating the set of headphones so that the wearer may express his or her self or individualize his or her set of headphones.

Decorative element 36 can be affixed to any portion of headphone wire 32, preferably to a portion that is highly visible. In the embodiment of FIG. 1a, decorative element 36 includes indicia 38 printed on one or both of its surfaces, which is effective to display various identifying characteristics or traits of the wearer, including personal facts, musical tastes, sports preferences, political affiliations, or any other characteristics or traits which can be conveyed visually. The decorative element 36 of FIG. 1a may be square-shaped, circular, rectangular, octagonal, hexagonal, pentagonal, oval-shaped or any other shape. Preferably, but certainly not required, decorative element 36 is shaped as an oval so that it resembles a musical note when connected to headphone wire 32.

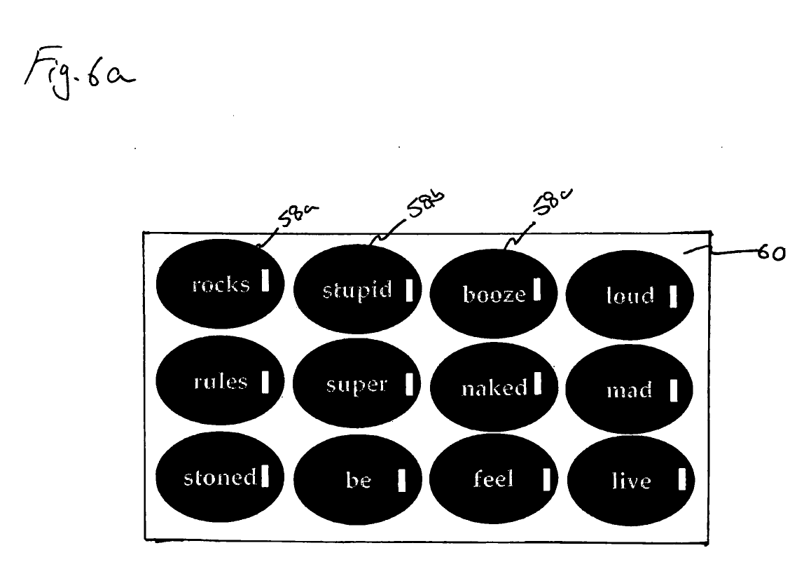

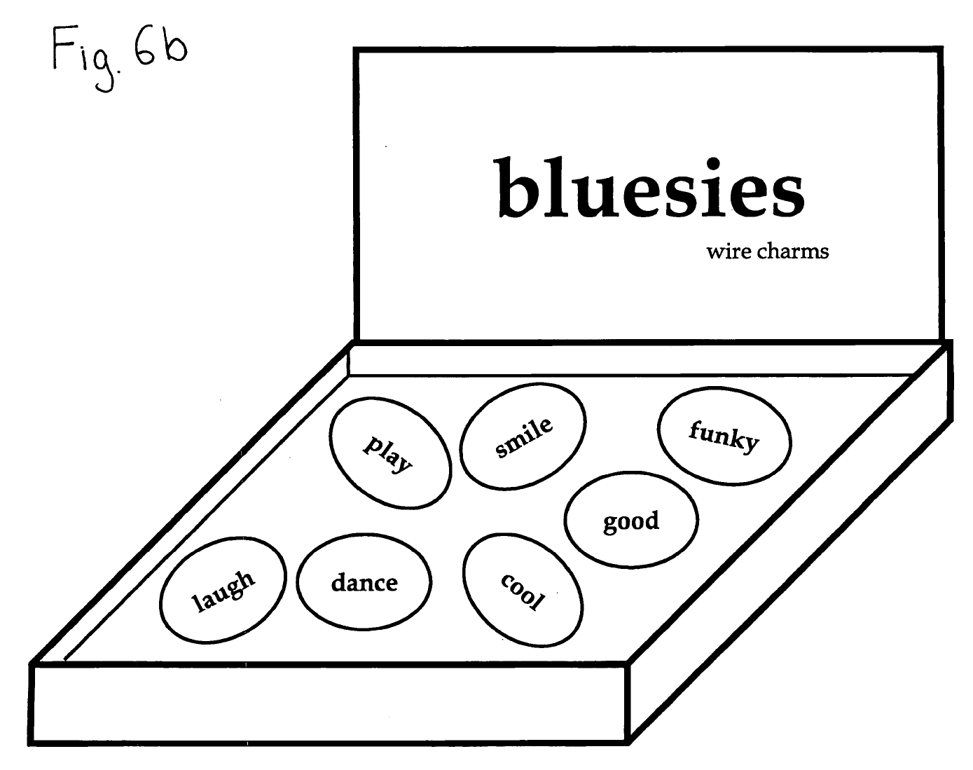

As shown in FIG. 6a, in one embodiment of the invention, printed indicia 38 includes words such as “rocks,” “mad,” and “feel,” each of which indicate a particular characteristic, trait or preference of the wearer. Other phrases may be printed on the decorative element to express the wearer's particular mood.

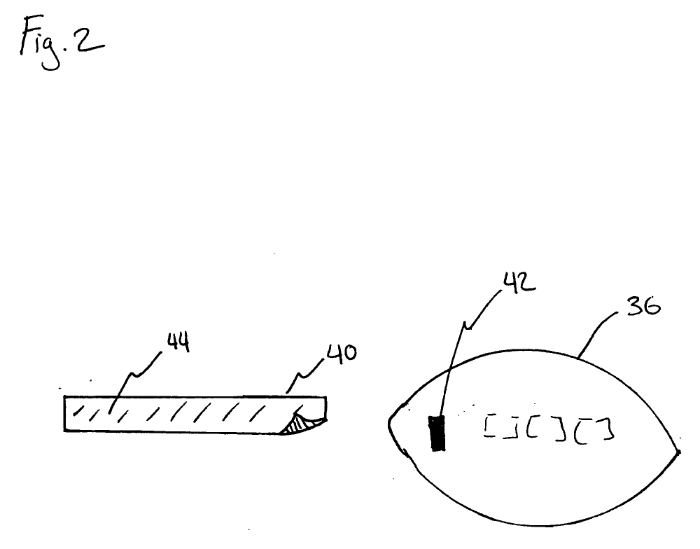

Referring now to FIG. 2, according to another embodiment of the invention, an assembly 39 is provided which includes a decorative element 36 and a connector device 40 for connecting decorative element 36 to headphone wire 32 (not shown). Connector device 40 is preferably an elongate flexible strip made of plastic, paper, or some other suitable material having a pressure-sensitive adhesive surface 44. Connector device 40 may be made of a transparent material. In this embodiment, decorative element 36 has an aperture 42 formed through one of its ends for receiving connector device 40.

In this embodiment, shown in FIG. 2, the connector device 40 is separate from the decorative element 36. However, as discussed below, in other embodiments of the invention, the connector device is integral with the decorative element 36.

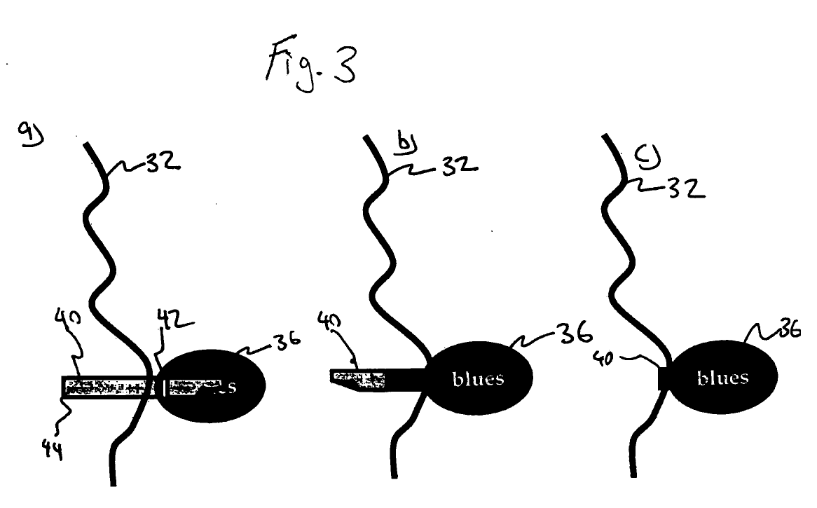

FIGS. 3a-c illustrate the method of connecting decorative element 36 to headphone wire 32 using connector device 40. Connector device 40 is inserted through aperture 42 of decorative element 36 and wrapped around headphone wire 32 to secure decorative element 36 to headphone wire 32. Aperture 42 is sized and shaped to easily receive and guide connector device 40 and connector device 40 is sized and shaped to wrap around headphone wire 32.

Pressure-sensitive adhesive surface 44 is exposed by removing a strip (not shown) covering the pressure-sensitive adhesive surface 44. After connector device 40 is wrapped around headphone wire 32, pressure-sensitive adhesive surface 44 is pressed against a surface of decorative element 36 or against a portion of connector device 40 to connect decorative element 36 to headphone wire 32. When connected, decorative element 36 preferably remains attached to headphone wire 32 so that it cannot slide down headphone wire 32 unless it is manually adjusted by the wearer. Alternatively, other suitable connector devices known in the art may be used to connect decorative element 36 to headphone wire 32, including but not limited to, clamps or clips.

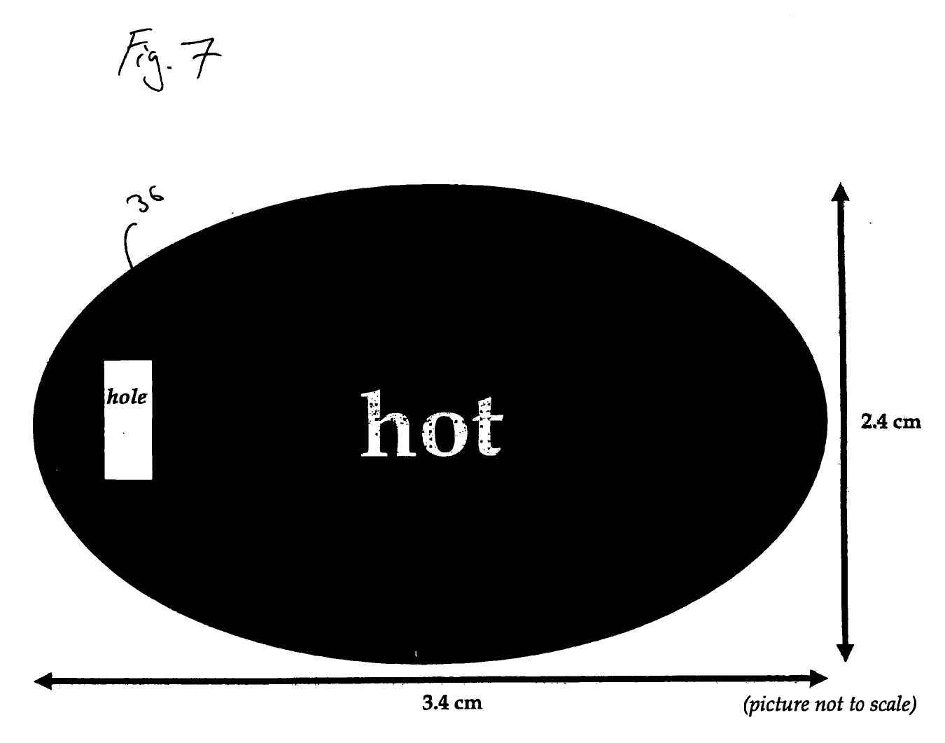

As shown in FIG. 7, the dimensions of decorative element 36 may be about 3.4 cm wide by about 2.4 cm high. Aperture 42 may be about 0.2 cm wide by about 0.7 cm high and may be located about 0.3 cm from the edge of decorative element 36. Decorative element 36 may be made out of a rigid material such as a thick paper or durable plastic.

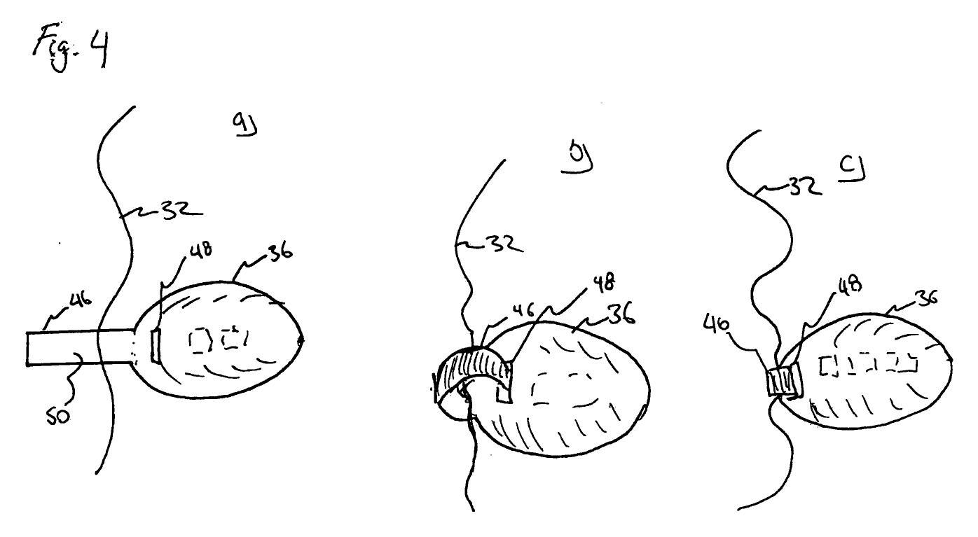

Referring now to FIGS. 4a-c, in accordance with another embodiment of the invention, an assembly is provided that includes a decorative element 36 and an integral connector portion 46 disposed at one end of decorative element 36. Connector portion 46 is preferably an elongate flexible strip made of plastic or paper with a pressure-sensitive adhesive surface 50. Decorative element 36 has an aperture 48 formed through its end proximate to connector portion 46.

In order to attach the decorative element to the wire 32 of a set of headphones, the wire is placed towards the end of connector portion 46 proximate to decorative element 36 and connector portion 46 is bent or wrapped around wire 32 and inserted through aperture 48. After connector portion 46 is wrapped around headphone wire 32, pressure-sensitive adhesive surface 50 is pressed against a surface of decorative element 36 or against a portion of connector portion 46 to secure decorative element 36 to headphone wire 32. Aperture 48 is sized and shaped to easily receive and guide connector portion 46. Pressure-sensitive adhesive surface 50 is exposed by removing a strip (not shown) covering the pressure-sensitive adhesive surface 50.

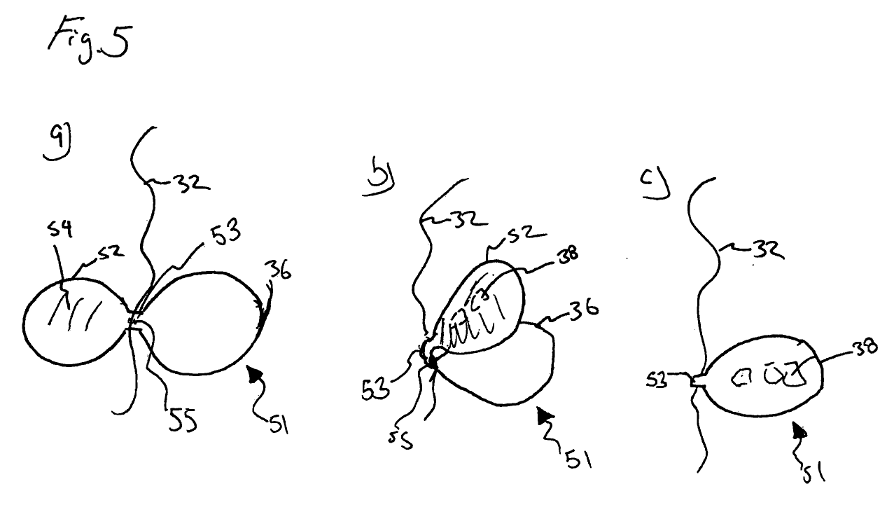

Referring now to FIGS. 5a-c, in another embodiment of the present invention, an assembly 51 includes a decorative element 36 and a connector portion 52 which is substantially similar in size and shape to decorative element 36. Assembly 51 also includes ajoining member 53 located between connector portion 52 and decorative element 36. Joining member 53 has a surface 55 that is covered partially or entirely by an adhesive.

In order to affix assembly 51 to the wire 32 of a set of headphones, a strip (not shown) is peeled from connector portion 52 to reveal a pressure-sensitive adhesive surface 54. Headphone wire 32 is positioned over joining member 53 and connector portion 52 is wrapped around headphone wire 32 and affixed to a rear surface of decorative element 36. When affixed, decorative element 36 and connector portion 46 have substantially the same shape and do not noticeably overlap. In addition, the adhesive, on joining member 53, sticks to headphone wire 32 when assembly 51 is connected, preventing assembly 51 from sliding down headphone wire 32, again, unless manually adjusted. Connector portion 52 may be transparent or may have indicia printed on its non-adhesive surface 56.

FIG. 6a depicts a kit as contemplated by one embodiment of the present invention. The kit includes a plurality of decorative elements, generally referred to by reference numerals 58a, 58b and 58c. Each of the decorative elements 58a, 58b and 58c is removably attached to a substrate 60. Decorative elements 58a, 58b, and 58c may be attached to the substrate by a light adhesive or may form part of the substrate so that they can be removed by “popping them out” along perforated edges. Decorative elements 58a, 58b, or 58c may be connected to headphone wire 32 as described above.

Decorative elements 58a, 58b, and 58c may all have the same indicia printed thereon or, alternatively, at least one of decorative elements 58a, 58b, or 58c may have a different indicia printed thereon so that the at least one decorative element is visually distinguishable from the others. In addition, decorative elements 58a, 58b, and 58c may all be of the same color or, alternatively, at least one of decorative elements 58a, 58b, or 58c may be of a different color.

The term “kit,” as used herein, is not limited to the embodiment shown in FIG. 6a, but also refers to a plurality of decorative elements arranged in a box (see FIG. 6b), envelope, or any other means so that the decorative elements can be sold together as a single unit.

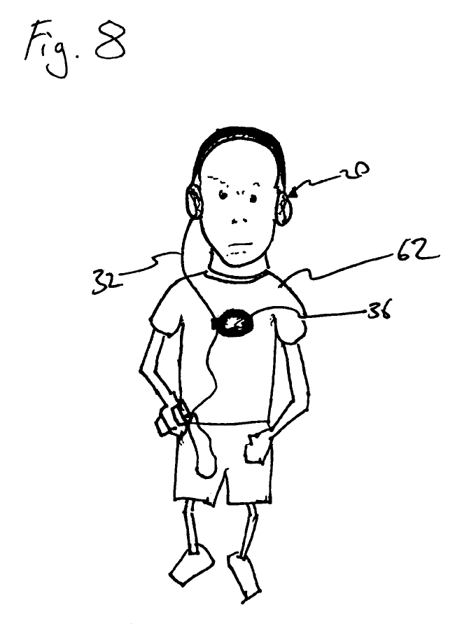

As shown in FIG. 8, decorative element 36 is clearly visible when the wearer 62 is wearing the headphone assembly 20. Decorative element 36 may be located at any location along headphone wire 32. When the user 62 is in a public location, decorative element 36 is visible by others so that they may understand the preferences, characteristics or other information that user 62 wishes to convey through decorative element 36 of headphone assembly 20.

Unless defined otherwise, all technical and scientific terms used herein have the same meaning as commonly understood by one of ordinary skill in the art to which this invention pertains. Although any methods and materials similar or equivalent to those described herein can also be used in the practice or testing of the present invention, the preferred methods and materials are now described.

The invention has been described with reference to exemplary embodiments that illustrate the principles of the invention and are not meant to limit the scope of the invention. Modifications and alterations may occur to others upon reading and understanding the preceding detailed description. It is intended that the scope of the invention be construed as including all modifications and alterations that may occur to others upon reading and understanding the preceding detailed description insofar as they come within the scope of the following claims or equivalents thereof. Various changes may be made without departing from the spirit and scope of the invention.

I claim:

1. A headphone assembly comprising:
a set of headphones having at least one speaker, an input plug, and a headphone wire connecting said input plug to said at least one speaker; and
a decorative element connected to said headphone wire.

2. The headphone assembly of claim 1, further comprising a connector device for connecting said decorative element to said headphone wire.

3. The headphone assembly of claim 2, wherein said decorative element has an aperture and said connector device is structured and arranged so that at least a portion thereof can be inserted through said aperture and wrap around and fasten said decorative element to a portion of the headphone wire.

4. The headphone assembly of claim 2, wherein the connector device is integral with the decorative element.

5. The headphone assembly of claim 2, wherein the connector device is separate from the decorative element.

6. The headphone assembly of claim 2, wherein the connector device has a substantially similar shape and size as the decorative element.

7. The headphone assembly of claim 1, wherein the shape of the decorative element is selected from the group consisting of square-shaped, circular, rectangular, octagonal, hexagonal, pentagonal, and oval-shaped.

8. The headphone assembly of claim 1, wherein the decorative element is a flat piece of material.

9. The headphone assembly of claim 8, wherein the decorative element is oval-shaped and is structured and arranged to resemble a musical note when coupled to the headphone wire.

10. The headphone assembly of claim 1, wherein the decorative element is a three-dimensional figurine.

11. An assembly for a headphone wire of a set of headphones, comprising a decorative element structured and arranged to be coupled to said headphone wire.

12. The assembly of claim 11, wherein said decorative element identifies a characteristic or preference of a wearer.

13. The assembly of claim 11, further comprising a connector device for connecting said decorative element to said headphone wire.

14. The assembly of claim 13, wherein said connector device is integral with the decorative element.

15. The assembly of claim 13, wherein said connector device is separate from the decorative element.

16. The assembly of claim 13, wherein said decorative element has an aperture for receiving at least a portion of said connector device.

17. A kit for use with a set of headphones, the kit comprising:
a plurality of decorative elements structured and arranged to be coupled to a portion of a headphone wire of said set of headphones; and
at least one connector device for attaching at least one of said decorative elements to said headphone wire.

18. A method of decorating a set of headphones having a headphone wire comprising the steps of:
providing at least one decorative element; and
coupling said decorative element to said headphone wire.

19. The method of claim 18, further comprising the steps of:
providing a connector device; and
coupling said decorative element to said headphone wire using said connector device.

20. The method of claim 19, further comprising the steps of:
coupling said decorative element to said headphone wire by inserting said connector device through an aperture formed in said decorative element.
